(19) United States
(12) Patent Application Publication
(10) Pub. No.: US 2025/0353480 A1
(43) Pub. Date: Nov. 20, 2025

(54) BRAKE CONTROL DEVICE, BRAKE SYSTEM AND METHOD FOR OPERATING SAME

(71) Applicant: Continental Automotive Technologies GmbH, Hannover (DE)

(72) Inventors: Thorsten Ullrich, Gernsheim (DE); Martin Baechle, Kelkheim (DE)

(73) Assignee: Continental Automotive Technologies GmbH, Hannover (DE)

(21) Appl. No.: 18/866,743

(22) PCT Filed: May 8, 2023
(86) PCT No.: PCT/DE2023/200088

§ 371 Date: Nov. 18, 2024

(30) Foreign Application Priority Data
May 18, 2022 (DE) 10 2022 204 954.3

(51) Int. Cl. B60T 13/74; B60T 13/14; B60T 13/58; B60T 13/68; B60T 17/04; B60T 17/06; B60T 17/22; F16D 65/78

(52) U.S. Cl. CPC B60T 13/745; B60T 13/148; B60T 13/588; B60T 13/686; B60T 17/04; B60T 17/06; B60T 17/22; F16D 65/78; B60T 2270/406; F16D 2065/782

(57) ABSTRACT

An electrohydraulic brake control device for hydraulically actuable wheel brakes has an electrically activatable hydraulic pressure source, an inlet valve for each of the hydraulically actuable wheel brakes, an outlet valve for each of the hydraulically actuable wheel brakes and a pressure medium reservoir. For at least one of the hydraulically actuable wheel brakes, the brake control device has a pressure build-up wheel connection and a pressure release wheel connection. Also, a brake system for a motor vehicle having such a brake control device and a method for operating such a brake system are also disclosed.

### TECHNICAL FIELD

A brake control device, a brake system for a motor vehicle and a method for operating the brake system are disclosed.

### BACKGROUND

The prior art discloses a hydraulically actuated wheel brake having a brake disk, a brake caliper and a brake pad, wherein the brake pad has a chamber which can be charged with a brake fluid and is enlarged in a braking phase and, in the process, presses the brake pad against the brake disk, having an inlet formed on the brake pad for introducing brake fluid into the chamber, the brake pad having a return which is separate from the inlet for removing brake fluid from the chamber. For cooling the brake pad, a brake system is designed in such a manner that brake fluid can be circulated through the chamber through the inlet and the return by means of a conveying unit.

A by-wire brake system with an electrohydraulic brake control device and four hydraulically actuable wheel brakes is known from the prior art. The brake control device comprises a master brake cylinder, an electrically controllable pressure source and precisely four hydraulic wheel connections for the four hydraulically actuable wheel brakes. Each of the four hydraulically actuable wheel brakes has a single connection which is connected to precisely one of the four hydraulic wheel connections of the electrohydraulic brake control device.

A so-called combined by-wire brake system having an electrohydraulic brake control device with a master brake cylinder and an electrically controllable pressure source, two hydraulically actuable wheel brakes and two wheel brakes, each actuable by an electromechanical actuator, is known from the prior art. Each of the two hydraulically actuable wheel brakes has a single connection which is connected to precisely one of the precisely two hydraulic wheel connections of the electrohydraulic brake control device.

Such by-wire brake systems must be filled with brake fluid (pressure medium) and, if necessary, evacuated appropriately using a filling device at the manufacturer plants of motor vehicle manufacturers.

### SUMMARY

It is an object to provide an electrohydraulic brake control device for a by-wire brake system and a by-wire brake system, enabling self-filling, i.e. filling with pressure medium without an additional filling device, such that time-consuming and error-prone processes in the manufacturer plant of the motor vehicle manufacturer are avoided.

It is a further object to provide methods for operating the brake system.

The concept regarding the electrohydraulic brake control device is based on the fact that the electrohydraulic brake control device for hydraulically actuable wheel brakes comprises an electrically activatable hydraulic pressure source, an inlet valve for each of the hydraulically actuable wheel brakes, an outlet valve for each of the hydraulically actuable wheel brakes and a pressure medium reservoir. For at least one of the hydraulically actuable wheel brakes, the brake control device has a pressure build-up wheel connection and a pressure release wheel connection. This means that the brake control device has two separate wheel connections for the at least one hydraulically actuable wheel brake, namely the pressure build-up wheel connection and the pressure release wheel connection.

The brake control device may be electrically controlled automatically by means of suitable activation of the electrically activatable pressure source and the inlet and outlet valves for at least one of the hydraulically actuable wheel brakes, can convey pressure medium from the electrically activatable pressure source via the inlet valve of the wheel brake, the pressure build-up wheel connection, the wheel brake and the pressure release wheel connection into the pressure medium reservoir. This enables self-filling or else purging of the wheel brake by the brake system itself when the brake system is installed in the vehicle.

For the at least one of the hydraulically actuable wheel brakes, the pressure build-up wheel connection is connected to the electrically activatable hydraulic pressure source via the inlet valve assigned to the hydraulically actuable wheel brake and the pressure release wheel connection is connected to the pressure medium reservoir via the outlet valve assigned to the hydraulically actuable wheel brake.

The brake control device is designed for hydraulically actuable wheel brakes, i.e. for at least two hydraulically actuable wheel brakes. Accordingly, the brake control device comprises at least two inlet valves and at least two outlet valves.

The brake control device may be designed for precisely two hydraulically actuable wheel brakes. It then comprises two inlet valves and two outlet valves for the two hydraulically actuable wheel brakes. Particularly, the brake control device comprises two pressure build-up wheel connections and two pressure release wheel connections, wherein the first pressure build-up wheel connection is connected to the electrically activatable hydraulic pressure source via the first inlet valve and the first pressure release wheel connection is connected to the pressure medium reservoir via the first outlet valve and wherein the second pressure build-up wheel connection is connected to the electrically activatable hydraulic pressure source via the second inlet valve and the second pressure release wheel connection is connected to the pressure medium reservoir via the second outlet valve. The first inlet valve may be connected to a pressure port of the first hydraulically actuable wheel brake via the first pressure build-up wheel connection and a first hydraulic connecting element and the first outlet valve is connected to a drain port of the first hydraulically actuable wheel brake via the first pressure release wheel connection and a second hydraulic connecting element, and the second inlet valve is connected to a pressure port of the second hydraulically actuable wheel brake via the second pressure build-up wheel connection and a further first hydraulic connecting element and the second outlet valve is connected to a drain port of the second hydraulically actuable wheel brake via the second pressure release wheel connection and a further second hydraulic connecting element.

The pressure medium reservoir may be a pressure medium reservoir under atmospheric pressure.

According to an embodiment, the brake control device for each of the hydraulically actuable wheel brakes in each case has a pressure build-up wheel connection and a pressure release wheel connection, wherein, for each of the hydraulically actuable wheel brakes, in each case the pressure build-up wheel connection is connected to the electrically activatable hydraulic pressure source via the inlet valve assigned to the respective hydraulically actuable wheel brake and the pressure release wheel connection is connected to the pressure medium reservoir via the outlet valve assigned to the respective hydraulically actuable wheel brake. This means that the electrohydraulic brake control device has two separate wheel connections for each of the hydraulically actuable wheel brakes. For each hydraulically actuable wheel brake, these are a pressure build-up wheel connection for supplying pressure medium from the electrically activatable pressure source via the brake control device inlet valve assigned to the corresponding wheel brake into the corresponding wheel brake and a pressure release wheel connection for discharging pressure medium from the corresponding wheel brake via the brake control device outlet valve assigned to the corresponding wheel brake into the pressure medium reservoir. This brake control device may be electrically controlled automatically by means of suitable activation of the electrically activatable pressure source and the inlet and outlet valves for each of the hydraulically actuable wheel brakes, can convey pressure medium from the electrically activatable pressure source via the inlet valve of the corresponding wheel brake, the associated pressure build-up wheel connection, the corresponding wheel brake and the associated pressure release wheel connection into the pressure medium reservoir. This enables self-filling or else purging of all of the wheel brakes or of the entire brake system by the brake system itself when the brake system is installed in the vehicle.

In the case that the electrohydraulic brake control device is designed for two hydraulically actuable wheel brakes, the brake control device thus has two pressure build-up wheel connections and two pressure release wheel connections, thus a total of four separate wheel connections for connecting the two hydraulically actuable wheel brakes. The two pressure build-up wheel connections are provided for building up pressure in the respective wheel brake, for example by means of the electrically activatable pressure source via the inlet valve assigned to the respective wheel brake, and the two pressure release wheel connections are provided for releasing pressure in the respective wheel brake, for example into the pressure medium reservoir via the outlet valve assigned to the respective wheel brake.

In the case that the electrohydraulic brake control device is designed for four hydraulically actuable wheel brakes, the brake control device accordingly has four pressure build-up wheel connections and four pressure release wheel connections, i.e. a total of eight separate wheel connections.

For the at least one of the hydraulically actuable wheel brakes or for each of the hydraulically actuable wheel brakes, within the brake control device, no hydraulic connecting line is provided between a wheel-brake-side connection of the inlet valve of the corresponding hydraulically actuable wheel brake and a wheel-brake-side connection of the outlet valve of the corresponding hydraulically actuable wheel brake.

In addition to the electrically activatable hydraulic pressure source, the electrohydraulic brake control device may not comprise any other hydraulic pressure source. The brake control device does not comprise a brake-pedal-actuable master brake cylinder for actuating the wheel brakes on a hydraulic fallback level. The brake control device also may not comprise a second electrically activatable hydraulic pressure source.

The electrically activatable hydraulic pressure source may be formed by a cylinder-piston arrangement with a pressure chamber and a piston, wherein the piston can be pushed forward and backward by an electromechanical actuator. This means that pressure medium can both be pushed into the wheel brakes and sucked up from the wheel brakes. To build up the brake pressure, the piston is moved forward (in the brake actuation direction) and moved backward (i.e. counter to the brake actuation direction) in order to release the brake pressure. The piston is also moved backward (i.e. counter to the brake actuation direction) in order to replenish pressure medium from the pressure medium reservoir into the pressure source.

The electrically activatable hydraulic pressure source, in particular the pressure chamber thereof, may be connected via an electrically actuable activation valve to a brake line section to which the inlet valves of the brake control device are connected. The activation valve may be configured to be normally closed. By means of the activation valve, the pressure source for replenishing pressure medium from the pressure medium reservoir can be hydraulically separated from the inlet valves.

The brake line section may be connectable to the pressure medium reservoir via an electrically actuable separation valve. This allows the inlet valves to be hydraulically connected to the pressure medium reservoir, thus depressurizing the wheel brakes. The separation valve may be configured to be normally open, and therefore, in the unactuated, de-energized state of the brake control device or the brake system, the wheel brakes are hydraulically connected to the pressure medium reservoir.

According to an embodiment, the brake line section is hydraulically connected directly to the pressure medium reservoir via the separation valve and a compensating line section.

According to another embodiment, the brake line section is connected to a pressure chamber of a master brake cylinder via the separation valve and a line section. The pressure chamber of the master brake cylinder may be connected to the pressure medium reservoir via one or more breather holes when the master brake cylinder piston is not actuated. This hydraulic connection between the pressure chamber and the pressure medium reservoir is disconnected when the master brake cylinder piston is sufficiently actuated in the actuation direction.

The pressure source may be formed by a cylinder-piston arrangement with a hydraulic pressure chamber, a suction port, and a pressure port, the piston of which is moved forward and backward or can be pushed forward and backward by an electromechanical actuator. The suction port may be connected to the pressure medium reservoir via a replenishing line with a non-return valve which opens in the flow direction toward the pressure chamber. The pressure connection may be connected to the brake line section via the activation valve.

The pressure medium reservoir has two reservoir chambers which may be separated by a bulkhead wall, wherein the outlet valves, and therefore the pressure release wheel connection or connections is or are connected to the one reservoir chamber and the replenishing line of the electrically activatable hydraulic pressure source is connected to the other reservoir chamber. This allows the brake control device to be self-vented or purged, especially when changing the pressure medium (brake fluid change) in the workshop or, when the vehicle is in operation. If steam bubbles arise in the brake system, e.g. as a result of reheating while the vehicle is stationary, this can be detected by means of an increased volume uptake in a test routine of the brake system after the vehicle has been parked. As a result, a self-venting cycle is then started, wherein the pressure medium reservoir acts as a gas bubble separator and the separation into the two reservoir chambers prevents foamed pressure medium (brake fluid) from being sucked up again.

The concept regarding the brake system is based on the fact that it comprises at least two hydraulically actuable wheel brakes and an electrohydraulic brake control device, wherein the electrohydraulic brake control device comprises an electrically activatable hydraulic pressure source, an inlet valve for each hydraulically actuable wheel brake, an outlet valve for each hydraulically actuable wheel brake and a pressure medium reservoir. For each of the hydraulically actuable wheel brakes, the brake control device is connected to the hydraulically actuable wheel brake via a first and a second (i.e. separate) hydraulic connecting element. This means that the brake system has two separate hydraulic connecting elements for each hydraulically actuable wheel brake, namely the first hydraulic connecting element and the second hydraulic connecting element, via which the brake control device is connected to the corresponding/respective hydraulically actuable wheel brake.

For each wheel brake, pressure medium from the brake control device can be directed into the hydraulically actuable wheel brake via the first hydraulic connecting element and pressure medium can be diverted separately therefrom via the second hydraulic connecting element from the wheel brake into the brake control device. Thus, self-filling or purging of the wheel brake by the brake system is possible by suitable automatic activation of the electrically activatable pressure source.

The brake control device for each of the hydraulically actuable wheel brakes has a pressure build-up wheel connection and a pressure release wheel connection. For each of the hydraulically actuable wheel brakes, the pressure build-up wheel connection may be connected to the electrically activatable hydraulic pressure source via the inlet valve assigned to the respective hydraulically actuable wheel brake and the pressure release wheel connection is connected to the pressure medium reservoir via the outlet valve assigned to the respective hydraulically actuable wheel brake. Thus, for each hydraulically actuable wheel brake, pressure medium can be directed from the brake control device via the pressure build-up wheel connection and the first hydraulic connecting element into the hydraulically actuable wheel brake, flow through the wheel brake and be discharged into the brake control device via the second hydraulic connecting element and the pressure release wheel connection.

For each hydraulically actuable wheel brake, the first hydraulic connecting element connects the inlet valve assigned to the hydraulically actuable wheel brake, via the brake control device pressure build-up wheel connection assigned to the inlet valve, to a pressure port of the hydraulically actuable wheel brake. This connection may be suitable for building up pressure in the hydraulically actuable wheel brake by means of the hydraulic pressure source.

For each hydraulically actuable wheel brake, the second hydraulic connecting element connects the outlet valve assigned to the hydraulically actuable wheel brake, via the brake control device pressure release wheel connection assigned to the outlet valve, to a drain port of the hydraulically actuable wheel brake. This connection is suitable for draining pressure from the hydraulically actuable wheel brake into the pressure medium reservoir of the brake control device.

The brake control device may be designed as an electrohydraulic brake control device.

The pressure medium reservoir may be a pressure medium reservoir under atmospheric pressure.

According to a development of the brake system, the latter may comprise at least one wheel brake actuable by an electromechanical actuator. The brake system comprises two wheel brakes each actuable by an electromechanical actuator. These two electromechanically actuable wheel brakes are assigned to a second vehicle axle of the motor vehicle. For example, the second vehicle axle is the rear axle of the motor vehicle. The brake system comprises precisely two wheel brakes (i.e. two electromechanically actuable wheel brakes) which are each actuable by an electromechanical actuator.

The brake system may compromise precisely two hydraulically actuable wheel brakes. These are assigned to a first vehicle axle of the motor vehicle. For example, two hydraulically actuable wheel brakes are assigned to the front axle of the motor vehicle.

According to a development of the brake system, the latter may comprise two hydraulically actuable wheel brakes, the electrohydraulic brake control device and two electromechanically actuable wheel brakes. The brake system comprises precisely two hydraulically actuable wheel brakes.

The brake system may comprise two hydraulically actuable wheel brakes, an electrohydraulic brake control device and two electromechanically actuable wheel brakes. The brake system comprises precisely two hydraulically actuable wheel brakes.

The brake system may comprise an actuating device which is designed to determine an actuating signal quantifying a braking desire as a result of an actuation by a vehicle driver, and which is connected to the electrohydraulic brake control device via a signal connection or a data connection for transmitting the actuating signal. The actuating device may be in the form of an electric brake pedal (ePedal). There may be no mechanical-hydraulic connection from the actuating device to the brake control device or the hydraulically actuable wheel brakes.

The electrohydraulic brake control device may comprise a first electronic control and regulating unit and a second electronic control and regulating unit, wherein the electrically activatable hydraulic pressure source is activated by the second electronic control and regulating unit and the inlet and outlet valves are activated by the first electronic control and regulating unit.

The electrically activatable hydraulic pressure source may be hydraulically connected separably via an electrically actuable activation valve to the inlet valves, wherein the activation valve is activated by the second electronic control and regulating unit.

The separation valve between the brake line section and the pressure medium reservoir may be activated by the second electronic control and regulating unit.

The brake system may comprise a first electrical partition and a second electrical partition, wherein the second electrical partition is independent of the first electrical partition.

The first electronic control and regulating unit of the electrohydraulic brake control device or the first electrical partition of the brake system may be supplied by a first electrical energy source and the second electronic control and regulating unit of the electrohydraulic brake control device or the second electrical partition of the brake system is supplied by a second electrical energy source which is independent of the first electrical energy source. The first energy source is thus part of the first electrical partition, and the second energy source is part of the second electrical partition.

The brake system may comprise two wheel brakes each actuable by an electromechanical actuator, wherein one of the wheel brakes actuable by an electromechanical actuator belongs to the first electrical partition of the brake system and the other of the wheel brakes actuable by an electromechanical actuator belongs to the second electrical partition of the brake system.

The brake system may comprise two wheel brakes (i.e. two electromechanically actuable wheel brakes) which are each actuable by an electromechanical actuator, wherein one of the wheel brakes actuable by an electromechanical actuator is supplied with electrical energy by means of a first electrical energy source and the other wheel brake actuable by an electromechanical actuator is supplied by means of a second electrical energy source which is independent of the first electrical energy source. The brake control device is supplied by the first and second electrical energy sources. The second electronic control and regulating unit of the brake control device and the electrically activatable hydraulic pressure source may be supplied with electrical energy by the first electrical energy source and the first electronic control and regulating unit and the inlet and outlet valves are supplied with electrical energy by the second electrical energy source.

The brake system may comprise two electromechanically actuable wheel brakes, wherein each of the electromechanically actuable wheel brakes comprises a separate electronic control and regulating unit for activating the electromechanical actuator of the electromechanically actuable wheel brake.

The brake system may have a first data bus, in particular a first CAN bus, and a second data bus, in particular a second CAN bus, or is connected to a first data bus and a second data bus.

The first data bus may connect the first electronic control and regulating unit of the electrohydraulic brake control device and the two electronic control and regulating units of the electromechanically actuable wheel brakes.

The second data bus may connect the first electronic control and regulating unit of the electrohydraulic brake control device and the two electronic control and regulating units of the electromechanically actuable wheel brakes.

The first data bus and the second data bus may be connected to a further electronic control and regulating unit, for example a central vehicle control/regulating unit. The actuating device is simply electrically connected to the further electronic control and regulating unit.

Each of the two electronic control and regulating units for activating one of the electromechanical actuators of the electromechanically actuable wheel brake is connected to both the first data bus and the second data bus. This provides a redundant supply of the driver's braking desire to the two electromechanically actuable wheel brakes.

The first data bus may connect the second electronic control and regulating unit of the electrohydraulic brake control device and the two electronic control and regulating units of the electromechanically actuable wheel brakes.

The hydraulically actuable wheel brakes of the brake system may each comprise a pressure medium chamber for actuating a brake element, wherein the pressure medium chamber may be connected to a pressure connection of the wheel brake for supplying pressure medium from the brake control device or for connecting to one of the inlet valves of the brake control device. In each case, the pressure medium chamber of the wheel brake is additionally connected to a drain port of the wheel brake for discharging pressure medium into the pressure medium reservoir of the brake control device or for connecting to one of the outlet valves of the brake control device.

The hydraulically actuable wheel brakes may not have any other vent connection equipped with a drain screw or a venting valve.

When one of the hydraulically actuable wheel brakes is installed in the vehicle, the drain port may be arranged above the pressure port. When the hydraulically actuable wheel brakes of the brake system are installed, the drain port for each wheel brake is arranged above the pressure port.

The concept regarding a method for operating a brake system is based on the fact that the brake control device is used to carry out a purging cycle in which
a) by actuating the electrically activatable hydraulic pressure source, in a brake actuation direction, pressure medium is displaced through a first inlet valve of the inlet valves, through the first hydraulically actuable wheel brake assigned to the first inlet valve and through the outlet valve assigned to the first hydraulically actuable wheel brake into the pressure medium reservoir or in the direction of the pressure medium reservoir and subsequently,
b) by actuating the electrically activatable hydraulic pressure source, counter to the brake actuation direction, pressure medium is sucked out of the pressure medium reservoir into the electrically activatable hydraulic pressure source,
wherein steps a) and b) are repeated cyclically.

The pressure medium reservoir of the brake system has a first and a second reservoir chamber, wherein the reservoir chambers are separated from each other by a bulkhead wall, and wherein the outlet valves are connected to the second reservoir chamber, and a replenishing line of the electrically activatable hydraulic pressure source is connected to the first reservoir chamber. In step a) pressure medium is conveyed into the second reservoir chamber and in step b) pressure medium is sucked up out of the first reservoir chamber into the pressure source. For example, a brake fluid change (pressure medium change) is easily possible in the workshop, by the old pressure medium being removed from the second reservoir chamber of the pressure medium reservoir and the new pressure medium being filled into the first reservoir chamber of the pressure medium reservoir.

The method is carried out first for one of the hydraulically actuable wheel brakes and then for another of the hydraulically actuable wheel brakes. A leak test of the brake system may then carried out by means of the brake control device, in which a test pressure is built up and maintained by means of the electrically activatable hydraulic pressure source.

In step a) the activation valve of the electrohydraulic brake control device is opened, the separation valve of the electrohydraulic brake control device is closed and the outlet valve assigned to the first hydraulically actuable wheel brake is opened before the electrically activatable hydraulic pressure source is actuated, for example in the brake actuation direction.

Step a) is ended when a piston of the electrically activatable hydraulic pressure source reaches a predetermined end point in the brake actuation direction, and the activation valve of the electrohydraulic brake control device is closed before step b) is started.

The method according is carried out after installation of the brake system. The method for filling the hydraulically actuable wheel brakes with pressure medium is carried out after the installation of the brake system. For example, method is carried out in a manufacturing plant of the motor vehicle.

The method for cooling the pressure medium is carried out. The method is carried out when a thermal loading of the brake system or of one of the wheel brakes is detected on the basis of a monitoring method. The monitoring method is carried out on the basis of a brake temperature model and/or on the basis of sensor data, for example on the basis of the data of a force sensor with a temperature output.

The method for venting the brake control device is carried out. The method is repeated and/or carried out in the presence of a predetermined condition. For example, the method is carried out repeatedly according to a predetermined time schedule.

### DESCRIPTION OF THE DRAWINGS

Further embodiments emerge from the dependent claims and the description below with reference to figures,

in which:

FIG. 1 shows a first exemplary embodiment of a brake control device,

FIG. 2 shows an exemplary embodiment of a brake system with a brake control device according to FIG. 1,

FIG. 3 shows a second exemplary embodiment of a brake control device, and

FIG. 4 shows an exemplary embodiment of a brake system with a brake control device according to FIG. 3.

### DETAILED DESCRIPTION

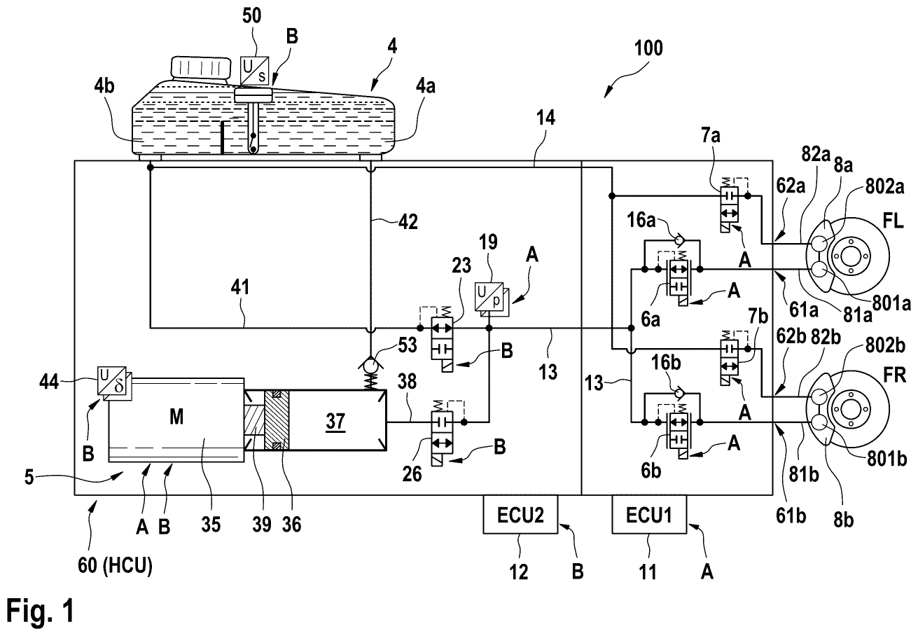

FIG. 1 schematically illustrates a first exemplary embodiment of a brake control device 100. The exemplary electrohydraulic brake control device 100 is designed for actuating two hydraulically actuable wheel brakes 8a, 8b. The brake control device 100 comprises an electrically activatable hydraulic pressure source 5, a pressure medium reservoir 4 under atmospheric pressure, and an electrically actuable inlet valve 6a, 6b and an electrically actuable outlet valve 7a, 7b for each wheel brake 8a, 8b.

The inlet valves 6a, 6b are normally open and the outlet valves 7a, 7b are normally closed.

As an example, the brake control device 100 comprises a first electronic control and regulating unit 11 (ECU1) and a second electronic control and regulating unit 12 (ECU2). Alternatively, the brake control device 100 may also comprise an electronic control and regulating unit ECU, which comprises two separate regions, e.g. in the form of a first printed circuit board (corresponds to 11) and a second printed circuit board (corresponds to 12). The following then applies correspondingly to the first and second region (the first and second printed circuit boards) instead of the first and second electronic control and regulating unit 11, 12.

The brake control device 100 is designed, for example, as an electrohydraulic unit (HECU) with a hydraulic control and regulating unit 60 (HCU, also called valve block) and the two electronic control and regulating units 11, 12 (ECU1, ECU2).

The electrically activatable hydraulic pressure source 5 is designed as a hydraulic cylinder-piston arrangement with a pressure chamber 37 and a piston 36 (i.e. as a single-circuit, electrohydraulic actuator (linear actuator)), the piston 36 of which can be pushed forward and backward by a schematically indicated electric motor 35 with interconnection of a likewise schematically illustrated rotation-translation mechanism 39. A rotor position sensor, merely schematically indicated, which serves to detect the rotor position of the electric motor 35 is denoted by reference sign 44.

The pressure chamber 37 of the pressure source 5 is connected via an electrically actuable activation valve 26 to a brake line section 13 to which the inlet valves 6a, 6b are connected. The activation valve 26 is normally closed. For this purpose, pressure chamber 37 is connected via a system pressure line 38 to the activation valve 26, which is connected on the output side to the brake line section 13.

A pressure sensor 19 which determines the system pressure generated by the pressure source 5 is arranged in the brake line section 13.

For replenishing pressure medium into the pressure source 5, the pressure chamber 37 is connected via a replenishing line 42 to a non-return valve (replenishing valve) 53 opening in the flow direction toward the pressure chamber 37 to the pressure medium reservoir 4, to a first chamber/LAC chamber 4a of the pressure medium reservoir. Thus, by moving the piston 36 backward with the activation valve 26 closed, pressure medium can flow out of the pressure medium reservoir 4, or out of the first chamber 4a of the pressure medium reservoir, via the replenishing line 42 into the pressure chamber 37.

In addition to the pressure source 5, the exemplary brake control device 100 does not comprise a further pressure source, i.e. neither a further electrically actuable pressure source nor a brake-pedal-actuable master brake cylinder is provided.

For each of the hydraulically actuable wheel brakes 8a, 8b, the brake control device comprises a pressure build-up wheel connection 61a, 61b and a (separate) pressure release wheel connection 62a, 62b. This means that two separate wheel connections (61 and 62) are provided for each hydraulically actuable wheel brake 8a, 8b, the pressure build-up wheel connection 61a, 61b and the pressure release wheel connection 62a, 62b, which are not directly connected to each other in the brake control device 100. For example, the wheel-brake-side connection of the respective inlet valve 6a, 6b is not connected to the wheel-brake-side connection of the corresponding outlet valve 7a, 7b via a hydraulic connection (connecting line).

For each hydraulically actuable wheel brake 8a, 8b, the electrically activatable hydraulic pressure source 5 is connected to the pressure build-up wheel connection 61a, 61b via the corresponding inlet valve 6a, 6b assigned to the hydraulically actuable wheel brake 8a, 8b. For each hydraulically actuable wheel brake 8a, 8b, the pressure release wheel connection 62a, 62b is connected to the pressure medium reservoir 4 via the corresponding outlet valve 7a, 7b assigned to the hydraulically actuable wheel brake 8a, 8b. As an example, the outlet valves 7a, 7b are connected via a return line 14 (which is common in certain parts) to the pressure medium reservoir 4, for example to a second chamber/return chamber 4b of the pressure medium reservoir. For pressure release by means of the outlet valves 7a, 7b, the pressure medium portion discharged via the outlet valves 7a, 7b flows via the return line 14 into the pressure medium reservoir 4, or into the second chamber of the pressure medium reservoir.

Accordingly, the brake control device 100 for each of the hydraulically actuable wheel brakes 8a, 8b is connected to the hydraulically actuable wheel brake 8a, 8b via a first hydraulic connecting element (first wheel line) 81a, 81b and via a second hydraulic connecting element (second wheel line) 82a, 82b.

The first hydraulic connecting element (first wheel line) 81a or 81b is connected on the one hand to the brake control device pressure build-up wheel connection 61a or 61b assigned to the wheel brake 8a or 8b (and thus to the corresponding inlet valve 6a or 6b) and on the other hand to a pressure connection 801a or 801b of the wheel brake 8a or 8b. The first wheel line 81a or 81b is used to build up pressure in the wheel brake by means of the hydraulic pressure source 5 (for building up wheel brake pressure).

The second hydraulic connecting element (second wheel line) 82a, 82b is connected on the one hand to the pressure release wheel connection 62a or 62b of the brake control device 100, which pressure release wheel connection is assigned to the wheel brake 8a or 8b (and is thus connected to the corresponding outlet valve 7a or 7b) and on the other hand to a drain port (802a or 802b) of the wheel brake 8a or 8b. Via the second wheel line 82a or 82b, draining of pressure medium from the wheel brake 8a or 8b is carried out via the outlet valve 7a or 7b into the pressure medium reservoir 4 of the brake control device 100 (for releasing wheel brake pressure).

A non-return valve 16a, 16b which opens in the direction of the brake circuit supply line 13 is connected in parallel with each of the inlet valves 6a, 6b.

In order to be able to depressurize the wheel brakes 8a, 8b as required, i.e. to be able to equalize the pressure of the wheel brakes 8a, 8b to the atmosphere, the brake line section 13 is connected to the pressure medium reservoir 4 via an electrically actuable separation valve 23 and an equalizing line section 41, is connected to the second chamber/return chamber 4b of the pressure medium reservoir. The separation valve 23 is normally open, in order for example in the switched off, de-energized state of the brake system to ensure pressure equalization of the wheel brakes to the atmosphere.

A level-measuring device 50 is arranged for determining a pressure medium level/state in the pressure medium reservoir 4. The level-measuring device 50 may be arranged in the first chamber/LAC chamber 4a of the pressure medium reservoir.

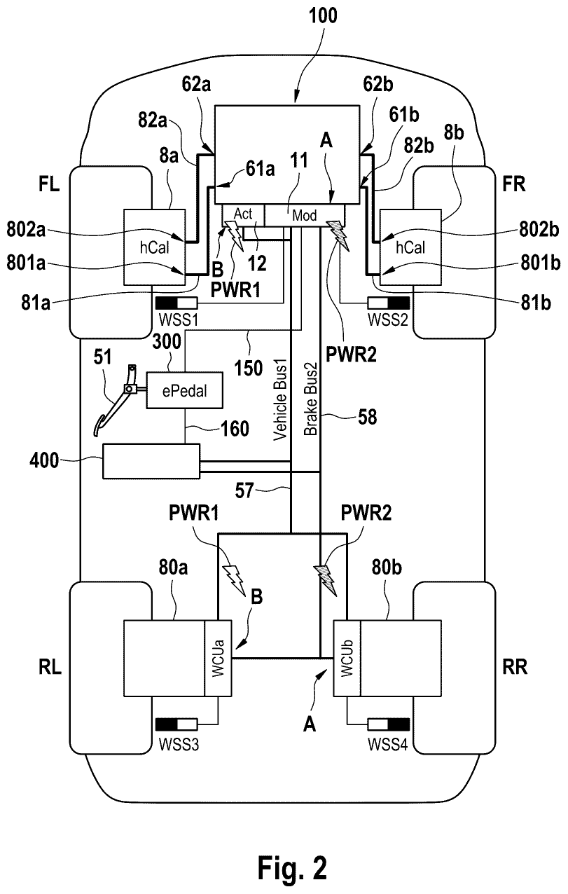

For the electrical attachment, connection and supply of the individual electrical or electrically actuable components of the brake control device 100 or brake system that can be activated, evaluated or the like (see FIG. 2), a first electrical partition A and a second electrical partition B are provided, which are electrically independent of one another.

In the figures, those electrical components that are assigned to or belong to the first electrical partition A are indicated by an arrow with A. Those electrical components that are assigned to or belong to the second electrical partition B are indicated by an arrow with B.

The first electronic control and regulating unit 11 is assigned or belongs to the first electrical partition A, whereas the second electronic control and regulating unit 12 is assigned or belongs to the second electrical partition B. Accordingly, the electronic control and regulating unit 11 and the second control and regulating unit 12 are electrically independent.

To supply the brake control device 100 or the brake system with electrical energy, a first electrical energy source PWR2, for example a vehicle electrical system, and a second electrical energy source PWR1, for example a second vehicle electrical system, which is independent of the first energy source, are provided. The first electrical energy source PWR2 supplies the first electrical partition A with energy, and the second electrical energy source PWR1 supplies the second electrical partition B.

The second electronic control and regulating unit 12 activates the pressure source 5. Accordingly, the first pressure source 5 is assigned to or associated with the second electrical partition B. According to the example, the first pressure source 5 is supplied with energy (from the second electrical energy source PWR1) via the second electronic control and regulating unit 12. According to the example, the first pressure source 5 can be or is activated exclusively by the second electronic control and regulating unit 12.

In order to achieve a redundancy of the activation of the pressure source 5, it is provided according to an embodiment that both partitions A and B (or both control and regulating units 11, 12 and both printed circuit boards) of the brake control device 100 are designed to activate the electric motor-driven pressure source 5 on the basis of actuation information. For this purpose, for example, both partitions A, B (or both control and regulating units 11, 12 or both printed circuit boards) are connected to a controller of the power electronics of the electric motor 35. In this way, even if one of the partitions A, B fails, a targeted control of the hydraulic pressure in the brake control device 100 is still possible. The pressure source 5 can be activated by/by means of the second electronic control and regulating unit 12 and by/by means of the first electronic control and regulating unit 11.

The remaining components of the brake system are assigned either to the first electronic control and regulating unit 11 (partition A) or to the second electronic control and regulating unit 12 (partition B). That is to say, said components are activated or actuated and/or supplied with electrical energy by said control and regulating unit, and/or are connected on the signal side to said control and regulating unit and/or are evaluated by said control and regulating unit. In order to avoid further redundancies, it is the case that a component is activatable or actuable by, or suppliable with electrical energy by, or connected on the signal side to, or evaluatable by, only or exclusively one of the two electronic control and regulating units 11, 12, but not by the other electronic controller.

In order to be able to activate the pressure source 5, the rotor position sensor 44 is assigned to the second electrical partition B. The signals from said sensor are supplied to the second electronic control and regulating unit 12 and evaluated and processed by the latter.

The activation valve 26 and the separation valve 23 are also assigned to the second electrical partition B and are activated by the second electronic control and regulating unit 12.

Furthermore, the signals from the level-measuring device 50 are supplied to the second electronic control and regulating unit 12 and evaluated and processed by the latter.

By contrast, the inlet and outlet valves 6a-6d, 7a-7d are assigned to the first electrical partition A and are activated by the first electronic control and regulating unit 11.

Pressure sensor 19 is also assigned to the first electrical partition A. The signals from said sensor are supplied to the first electronic control and regulating unit 11 and evaluated and processed by the latter.

FIG. 2 schematically illustrates a first exemplary embodiment of a brake system. FIG. 2 illustrates the system architecture of the brake system. The exemplary brake system comprises two hydraulically actuable wheel brakes 8a, 8b and two wheel brakes 80a, 80b (also referred to as electromechanically actuable wheel brakes 80a, 80b), each actuable by an electromechanical actuator, and an electrohydraulic brake control device 100 according to FIG. 1.

The hydraulically actuable wheel brakes 8a, 8b are arranged on the front axle of the vehicle (FL: left front wheel, FR: right front wheel), and the electromechanically actuable wheel brakes 80a, 80b (RL: left rear wheel, RR: right rear wheel) are arranged on the rear axle of the vehicle. Both the hydraulically and electromechanically actuable wheel brakes 8a, 8b, 80a, 80b are designed as service brakes of the vehicle.

The brake system is connected to a (brake) actuating device 300, which is designed to determine an actuating signal quantifying a braking desire as a result of an actuation by a vehicle driver. The actuating device 300 with brake pedal 51 is in the form of an electric brake pedal (ePedal). This means that there may not be mechanical-hydraulic connection from the actuating device 300 to the brake control device 100 or to the hydraulically actuable wheel brakes 8a, 8b. Direct mechanical/hydraulic actuation of the wheel brakes 8a, 8b by means of the actuating device 300 is not possible. The actuating device 300 is only connected to the brake control device 100 via a signal connection or data connection 150 for transmitting the actuating signal.

The pressure build-up wheel connection 61a of the brake control device 100 is hydraulically connected via the first wheel line 81a to the pressure port 801a of the wheel brake 8a, the pressure release wheel connection 62a of the brake control device 100 is hydraulically connected via the second wheel line 82a to the drain port 802a of the wheel brake 8a. Accordingly, the pressure build-up wheel connection 61b of the brake control device 100 is hydraulically connected via the first wheel line 81b to the pressure port 801b of the wheel brake 8b, and the pressure release wheel connection 62b of the brake control device 100 is hydraulically connected via the second wheel line 82b to the drain port 802b of the wheel brake 8b.

Each of the electromechanically actuable wheel brakes 80a, 80b may comprise, for example, a separate electronic control and regulating unit WCUa, WCUb (WCU: wheel control unit) for activating the corresponding electromechanical actuator of the wheel brake 80a, 80b.

Wheel brake 80a is supplied with electrical energy from the second electrical energy source (PWR1) (partition B), while wheel brake 80b is supplied with electrical energy from the first electrical energy source (PWR2) (partition A).

Each wheel FL, FR, RL, RR is assigned a wheel speed sensor WSS1, WSS2, WSS3, WSS4 (WSS: wheel speed sensor). The signals from the wheel speed sensor WSS3, WSS4 of the wheels with electro-mechanically actuable wheel brakes 80a, 80b are supplied to the respective electronic control and regulating unit WCU. The signals from the wheel speed sensor WSS1, WSS2 of the wheels with hydraulically actuable wheel brakes 8a, 8b are supplied to the first electronic control and regulating unit 11.

Furthermore, the brake system has a first data bus 57 (“Vehicle Bus1”), for example a CAN bus, which connects the first electronic control and regulating unit 11 and the electronic control and regulating units WCUa, WCUb. The brake system further comprises a second data bus 58 (“Brake Bus2”), for example a CAN bus, which connects the first electronic control and regulating unit 11 and the electronic control and regulating units WCUa, WCUb.

The electromechanically actuable wheel brakes 80a, 80b may be designed such that they also comprise a parking brake device.

Instead of two, e.g. spatially separated, electronic control and regulating units 11 and 12, a (single) control and regulating unit ECU may be provided, which comprises two electrically independent regions, e.g. in the form of two printed circuit boards. Then the one region, e.g. the first printed circuit board, is assigned to partition A and the other region, e.g. the second printed circuit board, is assigned to partition B.

The electrohydraulic front axle actuator (brake control device 100) consists of a hydraulic and an electronic control unit (HCU and ECU). The hydraulic front wheel brakes 8a, 8b are each connected to the HCU with a double pipeline (consisting of the first wheel line 81a, b and the second wheel line 82a, b). In each case, one line is used for building up pressure (first wheel line 81a, b) and one line for releasing pressure (second wheel line 82a, b).

The ECU has two partitions, here referred to as partition A and partition B. These partitions A, B are independent regions and each has its own microcontroller, which executes a customized software program. Partitions A, B are connected to each other via an internal ECU data bus. Both partitions A, B can preferably access or activate the actuators required for the pressure setting by means of the pressure source 5.

Partition A is electrically connected to the redundant actuating device 300 (ePedal) (connection 150) and converts the detected driver's braking desire into a corresponding BUS signal for activating the electromechanical rear wheel brakes 80a, 80b. For redundancy, the actuating device 300 (ePedal) is also electrically connected to an electronic control and regulating unit (ECU) 400 (connection 160) which may be external (to the brake system) and likewise converts the driver's desire into a corresponding BUS signal. Thus, the transmission of the driver's desire to the rear wheel brakes 80a, 80b (by means of the first data bus 57 (“Vehicle Bus1”) or the second data bus 58 (“Brake Bus2”)) is still possible, even if the brake control device 100 fails completely, e.g. due to a plug failure.

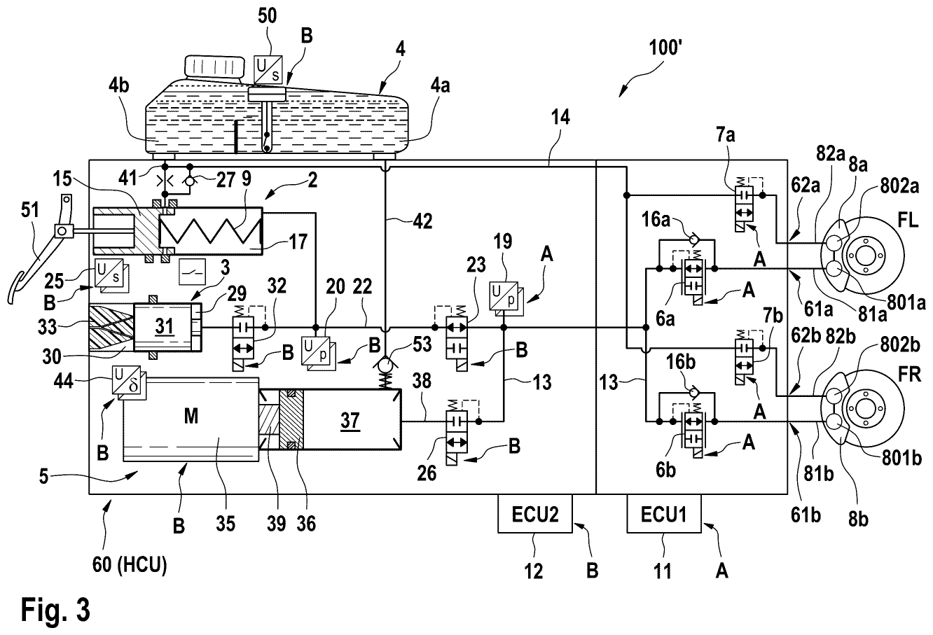

FIG. 3 schematically illustrates a second exemplary embodiment of a brake control device 100′. In contrast to the first exemplary embodiment of FIG. 3, the brake control device 100′ comprises a hydraulic fallback level with access of the driver to the wheel brakes 8a, 8b. For this purpose, the brake control device 100′ comprises a master brake cylinder 2 which is actuable by means of a brake pedal 51 and a simulation device 3 which interacts with the master brake cylinder 2.

The master brake cylinder 2 has a piston 15 in a housing (formed by the valve block), which bounds a pressure chamber 17. In the unactuated state of the master brake cylinder 2/of the piston 15, the pressure chamber 17 is connected via radial bores formed in the piston 15 and an equalizing line section 41 to the pressure medium reservoir 4, wherein this connection can be shut off by a relative movement of the piston 17 (when actuated) in the housing. A parallel connection of a throttle with a non-return valve 27 closing toward the pressure medium reservoir 4 is arranged in the equalizing line section 41. This means that the pressure chamber 17 is connected in an unactuated state of the piston 15 via one or more breather holes to the pressure medium reservoir 4, preferably to the second chamber/return chamber 4b of the pressure medium reservoir. This connection between pressure chamber 17 and pressure medium reservoir 4 is disconnected when the piston 15 is (sufficiently) actuated in the actuation direction.

The pressure chamber 17 accommodates a restoring spring 9 which, when the master brake cylinder 2 is not actuated, positions the piston 15 in a starting position. A piston rod 24 couples the pivoting movement of the brake pedal 51 resulting from a pedal actuation to the translational movement of the (master brake cylinder) piston 15, the actuation travel of which is detected by a travel sensor 25, which is preferably of redundant design. In this way, the corresponding piston travel signal is a measure of the brake pedal actuation angle. It represents the vehicle driver's braking desire.

Pressure chamber 17 is connected to the separation valve 23 by means of a hydraulic line 22. The hydraulic connection between the pressure chamber 17 and the brake circuit supply line 13 can be shut off by the separation valve 23. A pressure sensor 20 connected to the line section 22 detects the pressure built up in the pressure chamber 17 by displacement of the piston 15. This pressure also represents a measure of the vehicle driver's braking desire.

Simulation device 3 is hydraulically coupled to the master brake cylinder 2. The simulation device 3 consists essentially of a simulator chamber 29, a simulator rear chamber 30 and a simulator piston 31 which separates the two chambers 29, 30 from one another. Simulator piston 31 is supported on the housing (valve block) by a resilient element 33 (for example a simulator spring) arranged in the simulator rear chamber 30. The simulator chamber 29 is, as an example, connectable to the pressure chamber 17 of the master brake cylinder 2 by means of an electrically actuable simulator enable valve 32.

As an example, the pressure source 5 is activated exclusively by means of the second electronic control and regulating unit 12, since redundancy of the activation of the pressure source 5 is not absolutely necessary because of the master brake cylinder 2/the hydraulic fallback level.

The simulator enable valve 32 is assigned to the second electrical partition B and is activated by the second electronic control and regulating unit 12.

Pressure sensor 20 and travel sensor 25 are also assigned to the second electrical partition B. The signals from said sensors are supplied to the second electronic control and regulating unit 12 and evaluated and processed by the latter.

The remaining components of the brake control device 100′ have already been explained in connection with FIG. 1 (brake control device 100).

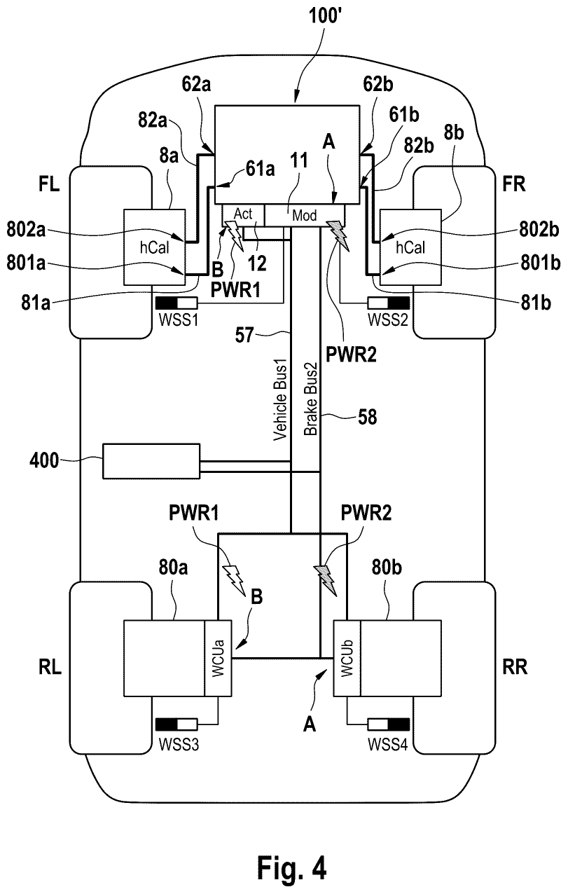

FIG. 4 schematically illustrates a second exemplary embodiment of a brake system. FIG. 4 illustrates the system architecture of the brake system. The exemplary brake system comprises two hydraulically actuable wheel brakes 8a, 8b and two electromechanically actuable wheel brakes 80a, 80b and an electrohydraulic brake control device 100′ according to FIG. 3. Otherwise, the system architecture of the second exemplary embodiment corresponds to the system architecture of the first exemplary embodiment of FIG. 2 with the difference that no actuating device 300 (and the signal/data connection thereof) is provided, since the brake control device 100′ comprises a master brake cylinder 2 with brake pedal 51.

A common feature of the exemplary embodiments is that the hydraulic wheel brakes 8a, 8b are connected to the brake control device 100, 100′ via in each case two wheel lines 81a, 81b and 82a, 82b.

The first wheel line 81a, 81b is used for building up pressure, which is effected by means of the electrically actuated pressure source 5 (by pushing the piston 36 forward) via the open inlet valves 6a, 6b (with closed outlet valves 7a, 7b). In this case, the activation valve 26 is opened and the separation valve 23 is closed.

A pressure release for releasing all of the wheel brakes 8a, 8b (e.g. for normal braking, e.g. without anti-lock braking control) is usually effected by pulling back the piston 36 in the reverse direction, so to speak, by pressure medium being sucked into the pressure chamber 37 by means of the electrically actuated pressure source 5 by pulling back the piston 36 via the first wheel lines 81a, 81b, the open inlet valves 6a, 6b and the open activation valve 26 (with the separation valve 23 closed).

In an anti-lock braking control system, i.e. with a wheel-specific pressure setting, a (wheel) pressure release is achieved by closing the corresponding inlet valve and opening the corresponding outlet valve. This causes the pressure to be released into the pressure medium reservoir 4 via the second wheel line 82a, 82b.

This results (in total) in an annular flow, i.e. pressure medium is transported from the pressure medium reservoir 4 into the pressure source 5 (during replenishing), via the inlet valves 6a, 6b and the first wheel lines 81a, 81b into the wheel brakes 8a, 8b, via the second wheel line(s) 82a, 82b and the outlet valve(s) 7a, 7b back into the pressure medium reservoir 4. This annular flow is suitable for regularly purging the brake control device or the brake system. Any air bubbles which are present are removed and eliminated in the pressure medium reservoir 4.

A method for initial filling/self-filling of the brake system is:
the brake control device 100, 100′ is delivered pre-filled with pressure medium (brake fluid) additionally held in readiness in the pressure medium reservoir 4 and installed in the vehicle. The wheel lines 81a, 81b, 82a, 82b and brake calipers of the wheel brakes 8a, 8b are installed dry, i.e. unfilled. After all of the connections and the electrical energy supply have been produced, the brake control device 100, 100′ is able to fill the previously dry wheel lines 81a, 81b, 82a, 82b and wheel brakes 8a, 8b via the annular flow explained above.

The filling can then be checked by means of the angle/position sensor 44 and the pressure sensor 19 of the pressure source 5 and, if necessary, an error message can be output if a leak is detected.

The brake calipers of the wheel brakes 8a, 8b and their connection to the wheel lines and the installation position of the connections (pressure build-up wheel connections 61a, 61b and pressure release wheel connections 62a, 62b) should be designed in such a way that the pressure medium (pressure build-up wheel connection 61a, 61b) is supplied at the geometric lower region, and the pressure medium (pressure release wheel connection 62a, 62b) is discharged via the geometrically upper region such that no air pockets remain in the brake caliper. There is no need to install vent screws on the brake caliper.

The following method steps for the self-filling are carried out:
purging a wheel brake, such as wheel brake 8b (FR), (first purging cycle):
a) Opening the activation valve 26, closing the separation valve 23, opening the outlet valve 7b assigned to the wheel brake.
b) Actuating the piston 36 of the pressure source 5 (in the forward direction/brake actuation direction).
Thus, pressure medium volume is pushed through the open inlet valve 6b, the first wheel line 81b, the wheel brake (brake caliper) 8b, the second wheel line 82b, the opened outlet valve 7b in the direction of the pressure medium reservoir 4.
c) When the piston 36 of the pressure source 5 arrives at the front end (right-hand end in FIGS. 1, 3) (this can be monitored by the angle sensor 44 or a displacement sensor around piston 36), the activation valve 26 is closed, the piston 36 of the pressure source 5 is retracted (i.e. counter to the brake actuation direction) and so pressure medium is replenished from the pressure medium reservoir 4 into the pressure chamber 37.
d) Repeat steps a) to c) several times if necessary.

Purging other wheel brake, such as wheel brake 8a (FL), (second purging cycle):
a) Opening the activation valve 26, closing the separation valve 23, opening the outlet valve 7a assigned to the wheel brake.
b) Actuating the piston 36 of the pressure source 5 (in the forward direction/brake actuation direction).
Thus, pressure medium volume is pushed through the open inlet valve 6a, the first wheel line 81a, the wheel brake (brake caliper) 8a, the second wheel line 82a, the opened outlet valve 7a in the direction of the pressure medium reservoir 4.
c) When the piston 36 of the pressure source 5 arrives at the front end (right-hand end in FIGS. 1, 3) (this can be monitored by the angle sensor 44 or a displacement sensor around piston 36), the activation valve 26 is closed, the piston 36 of the pressure source 5 is retracted (counter to the brake actuation direction) and so pressure medium is replenished from the pressure medium reservoir 4 into the pressure chamber 37.
d) Repeat steps a) to c) several times if necessary.

The following method steps for leak testing are carried out:
a) Closing the separation valve 23, opening the activation valve 26, all other valves (6a, 6b, 7a, 7b, if necessary 32) remain unenergized (i.e. the inlet valves are open, the outlet valves are closed).
b) Constructing a test pressure, e.g. of 100 bar (by means of the pressure source 5). The displacement pressure medium volume required to reach the test pressure is determined.
c) Waiting for a (short) stabilization time.
d) Starting a measurement phase.
At least one of the following variables is monitored by means of one of the sensors of the brake control device: pressure medium volume change (e.g. by means of angle/position sensor 44 of the pressure source 5), pressure drop (e.g. by means of the pressure sensor 19)
A pressure medium volume change during a specified measurement time must not take place.
Alternatively, a pressure drop must not take place at a held pressure medium volume or is compared with specified test values/comparison values.
The displacement pressure medium volume required to reach the test pressure is compared with a specified value.
e) Ending the leak test.

The self-filling method is completed by enabling the brake system.

In addition to self-filling, the brake control device or the brake system allows further methods for operation, which restore or improve the functionality of the brake control device or the brake system (e.g. active pressure medium cooling, self-venting).

When descending from a pass (e.g. when descending from the Grossglockner pass), the wheel brakes are subjected to a high thermal loading. If there is a suspicion of overheating of the pressure medium (the brake fluid), a corresponding purging process/purging cycle as in the self-filling is carried out for active cooling of the pressure medium. The same purging process/purging cycle (steps a) to c)) may be carried out for pressure medium cooling if the driver is not currently braking. If the driver is braking continuously, the purging process/purging cycle is embedded in the braking process. For example, the pressure medium annular flow can be superimposed on the normal braking, similarly to an anti-lock braking control.

The following method steps may be carried out, especially in driving situations that thermally load the wheel brakes (active pressure medium cooling):
a thermal loading is monitored and detected by means of a brake temperature model, optionally also by means of existing sensors, e.g. a force sensor with temperature output, which is arranged in the electromechanical wheel brake.

If there is a suspicion of overheating of the pressure medium, a purging cycle is carried out. Alternatively, both wheel brakes can be subject to a purging process/purging cycle simultaneously or one after the other. In this case, the heated pressure medium is directed away from the hydraulically actuated wheel brake or brakes 8a, 8b (from the brake caliper) to the pressure medium reservoir 4 (via the second wheel lines 82a, 82b) (see purging cycle steps a), b)). New cold pressure medium flows in from the pressure medium reservoir 4 (see purging cycle step c)). This can avert the formation of steam bubbles or prevent the formation of steam bubbles.

In order to improve the effect, the second wheel lines 82a, 82b are provided with an enlarged surface (e.g. with cooling fins) or to form a heat sink.

If a purging process/purging cycle is carried out during a braking operation, the braking torque at the electromechanically actuated wheel brakes 80a, 80b (e.g. of the rear axle) is increased by the missing amount of the braking torque of the hydraulically actuated wheel brake(s) 8a, 8b (e.g. of the front axle) during the purging cycle for compensation purposes. This means that the driver will not notice any change in the deceleration.

Alternatively, the purging process/purging cycle can be performed in a haptically perceptible way so that the driver receives feedback about the hazardous situation. For example, the missing braking torque of the hydraulically actuated wheel brake(s) during the purging cycle is not compensated for by increasing the braking torque at the electromechanically actuated wheel brakes 80a, 80b.

The above-described method of active pressure medium cooling affords that a brake fluid change may be omitted or delayed, or that the wheel brakes 8a, 8b can be thermally designed with less reserve.

The purging cycle described above is also a venting cycle that can be carried out regularly (e.g. according to a predetermined time schedule) and/or in the presence of certain conditions (e.g. after a measured multi-volume uptake) by the brake system/the brake control device (self-venting).

If, for example, steam bubbles form after a previous thermal loading in the switched off state (so-called heat soak), workshop venting can be avoided after starting the brake system, since the brake system/brake control device carries out the venting automatically by performing purging cycles.

The brake fluid change in the workshop is also simplified with the brake control device or the brake system. During the purging cycle, the old brake fluid (the old pressure medium) only has to be removed from the second chamber/return chamber 4b of the pressure medium reservoir 4 and the new brake fluid (the new pressure medium) filled into the first chamber/LAC chamber 4a of the pressure medium reservoir 4. A change cycle is carried out via the liquid level warning device.

The brake control device 100, 100′ can be delivered pre-filled to the vehicle manufacturer, who installs the brake control device with unfilled wheel lines (81, 82) and wheel brake calipers (wheel brakes 8a, 8b) in the vehicle, and after installation and starting of the brake system, the brake system or the brake control device carries out a self-filling process.

1. An electrohydraulic brake control device for hydraulically actuable wheel brakes comprising:
an electrically activatable hydraulic pressure source,
an inlet valve for each of the hydraulically actuable wheel brakes,
an outlet valve for each of the hydraulically actuable wheel brakes,
a pressure medium reservoir, and
at least one pressure build-up wheel connection and at least one pressure release wheel connection for at least one of the hydraulically actuable wheel brakes.

2. The electrohydraulic brake control device as claimed in claim 1, wherein the pressure build-up wheel connection is connected to the electrically activatable hydraulic pressure source via the inlet valve assigned to the at least one hydraulically actuable wheel brake and the pressure release wheel connection is connected to the pressure medium reservoir via the outlet valve assigned to the at least one hydraulically actuable wheel brake.

3. The electrohydraulic brake control device as claimed in claim 1, wherein the at least one pressure build-up wheel connection and the at least one pressure release wheel connection are a plurality of connections, and wherein each of the hydraulically actuable wheel brakes has one of the plurality of pressure build-up wheel connections and one of the plurality of pressure release wheel connection, wherein, for each of the hydraulically actuable wheel brakes, the respective pressure build-up wheel connection is connected to the electrically activatable hydraulic pressure source via the inlet valve assigned to the respective hydraulically actuable wheel brake and the respective pressure release wheel connection is connected to the pressure medium reservoir via the outlet valve assigned to the respective hydraulically actuable wheel brake.

4. The electrohydraulic brake control device as claimed in claim 1, wherein the electrically activatable hydraulic pressure source is formed by a cylinder-piston arrangement with a pressure chamber and a piston, wherein the piston can be pushed forward and backward by an electromechanical actuator.

5. The electrohydraulic brake control device as claimed in claim 1, wherein the electrically activatable hydraulic pressure source is connected via an electrically actuable activation valve to a brake line section to which the inlet valves are connected.

6. The electrohydraulic brake control device as claimed in claim 5, wherein the brake line section is connectable to the pressure medium reservoir via an electrically actuable separation valve.

7. The electrohydraulic brake control device as claimed in claim 1, wherein the pressure medium reservoir has a first reservoir chamber and a second reservoir chamber, which are separated from each other by a bulkhead wall, wherein the electrically activatable hydraulic pressure source is connected via a replenishing line by a non-return valve opening in the direction of the pressure source to the first reservoir chamber of the pressure medium reservoir, and wherein the pressure release wheel connection is connected to the second reservoir chamber.

8. A brake system for a motor vehicle having at least two hydraulically actuable wheel brakes comprising:
an electrohydraulic brake control device,
an electrically activatable hydraulic pressure source,
an inlet valve for each hydraulically actuable wheel brake,
an outlet valve for each hydraulically actuable wheel brake,
a pressure medium reservoir,
a first and a second hydraulic connecting element for each hydraulically actuable wheel brake, wherein the brake control device is connected to the hydraulically actuable wheel brake via the first and the second hydraulic connecting element.

9. The brake system as claimed in claim 8, wherein each of the hydraulically actuable wheel brakes has a pressure build-up wheel connection and a pressure release wheel connection.

10. The brake system as claimed in claim 8, wherein for each hydraulically actuable wheel brake, the first hydraulic connecting element connects the inlet valve assigned to the hydraulically actuable wheel brake to a pressure port of the hydraulically actuable wheel brake, and for each hydraulically actuable wheel brake, the second hydraulic connecting element connects the outlet valve assigned to the hydraulically actuable wheel brake to a drain port of the hydraulically actuable wheel brake.

11. (canceled)

12. The brake system as claimed in claim 8, further comprising at least one wheel brake actuable by an electromechanical actuator.

13. The brake system as claimed in claim 12, wherein the at least one wheel brake is two wheel brakes each actuable by an electromechanical actuator, wherein one of the wheel brakes actuable by an electromechanical actuator is supplied with electrical energy by a first electrical energy source and the other wheel brake actuable by an electromechanical actuator is supplied by a second electrical energy source which is independent of the first electrical energy source.

14. A method for operating a brake system with a brake control device to carry out a purging cycle comprises:
a) actuating an electrically activatable hydraulic pressure source in a brake actuation direction to displace pressure medium through an inlet valve through a hydraulically actuable wheel brake assigned to the inlet valve and through an outlet valve assigned to the hydraulically actuable wheel brake in a direction of a pressure medium reservoir, and subsequently
b) actuating the electrically activatable hydraulic pressure source, in in a direction counter to the brake actuation direction to suction pressure medium out of the pressure medium reservoir into the electrically activatable hydraulic pressure source, and
cyclically repeating steps a) and b).

15. The method as claimed in claim 14, where the hydraulically actuable wheel brake is a plurality of hydraulically actuable wheel brake, and where the method is carried out first for one of the plurality of hydraulically actuable wheel brakes and then for another of the plurality of hydraulically actuable wheel brakes.

16. The method as claimed in claim 15, further comprising carrying out a leak test of the brake system with the brake control device, by building and maintaining a test pressure with the electrically activatable hydraulic pressure source.

17. The method as claimed in claim 14, further comprising in step a) an activation valve arranged between the electrically activatable hydraulic pressure source and the inlet valves is opened, a separation valve arranged between the inlet valves and the pressure medium reservoir is closed and the outlet valve assigned to the hydraulically actuable wheel brake is opened before the electrically activatable hydraulic pressure source is actuated in the brake actuation direction.

18. The method as claimed in claim 14, wherein step a) is ended when a piston of the electrically activatable hydraulic pressure source reaches a predetermined end point in the brake actuation direction, and the activation valve is closed before step b) is started.

19. The method as claimed in claim 14 wherein method is carried out after the installation of the brake system for filling the hydraulically actuable wheel brakes with pressure medium.

20. The method as claimed in claim 14, wherein the method is carried out for cooling the pressure medium when a thermal load of the brake system or the wheel brake is detected on the basis of a monitoring method.

21. The method as claimed in claim 20, wherein the monitoring method is carried out based on at least one of: a brake temperature model, sensor data, and data of a force sensor with a temperature output.

22. The method as claimed in claim 14, wherein the method is repeated for venting the brake control device in the presence of a predetermined condition.
